(19) United States
(12) Patent Application Publication
(10) Pub. No.: US 2008/0094520 A1
(43) Pub. Date: Apr. 24, 2008

(54) Simplified Switch Over Between Content Related Media Streams

(75) Inventors: Serhiy Tkachenko, Geldrop (NL); Alan David MacDuff, Eindhoven (NL); Ilija Pjanovic, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/574,744

(22) PCT Filed: Aug. 30, 2005
(86) PCT No.: PCT/IB05/52834

§ 371 Date: Mar. 6, 2007

(30) Foreign Application Priority Data
Sep. 9, 2004 (EP) 04104357.1

(51) Int. Cl. H04N 5/268

(52) U.S. Cl. 348/705; 348/E05.057

(57) ABSTRACT

The invention relates to methods, devices and computer program codes for enabling simple seamless switch over between content related media streams, selecting a switching scheme and performing simplified switch over between such streams, as well as a set of media signals. The media streams (TS1, TS2, TSN) have access units (AU1, AU2, AU3), the lengths of which are made equal by adding filling packets (N). By doing this, overhead data (O1, O2, ON) related to the streams can also be made almost identical. This fact is then used for fast determination of switch over method and simplified seamless switch over between different media streams.

### TECHNICAL FIELD

The present invention is generally related to manipulation of media data streams and more particularly to methods, devices and computer program codes for enabling simple seamless switch over between content related media streams, selecting a switching scheme and performing simplified seamless switch over between such streams, as well as a set of media signals.

### BACKGROUND OF THE INVENTION

In recent years a number of standards have been developed for recording media data on data carriers, where examples of such standards are DVD (Digital Versatile Disc) and Blu-ray video disc. In for instance Blu-ray it is possible to allow a user to seamlessly connect with each other two streams or clips provided on a Blu-ray disc.

In Blu-ray it is also possible nowadays to provide several streams of related content together, where this related content can be video shot from different angles and coded using MPEG. Blu-ray thus provides the possibility of viewing the same scene from different angles. Here the different angles are always provided in separate streams or clips together with overhead data, normally comprising so called EP tables that include switch over markers, where it is possible to switch over from one angle to the other. However, Blu-ray imposes certain limitations on angle streams, where one is that the only thing allowed to be varied is the video and certain frame synchronization information. The user can furthermore not notice the moment of change. This situation is called the “seamless angle change”.

Different angles and switching between them is for instance described in EP-872838. This document describes providing different angles on a DVD disc. It is here possible to switch between the angles to see the same scene from the different angles. However, in DVD the different angles are provided in the same media stream.

Because the angles are provided as separate streams in for instance the case of Blu-ray, the video coding will take up different amounts of time or frames. In order to switch over from one clip to the other it would then be necessary to analyze the overhead data of the first clip in order to find a suitable switch over position. This is however not enough. In order to find the corresponding switch over position of the second clip, the corresponding overhead data of that second clip has to be located and analyzed. Only then is it possible to switch to the second clip. This is both time-consuming and makes the required media playing device unnecessarily complex.

It would therefore be advantageous if the locating operation could be simplified, so that the amount of overhead data needed to be analyzed is reduced to a minimum.

### SUMMARY OF THE INVENTION

The present invention is therefore directed towards solving the above-mentioned problem of enabling the limitation of overhead data analysis in relation to seamless switch over between content related media streams.

One object of the present invention is thus to provide a method of enabling simple seamless switch over between at least two content related media streams.

According to a first aspect of the present invention, this object is achieved by a method of enabling simple seamless switch over between at least two content related media streams each comprising a number of access units having packets and the method comprising the steps of:
obtaining substreams of a first type in a number corresponding to the number of content related media streams to be provided and also being grouped into access units,
obtaining a timing marker for each access unit of the different substreams of the first type,
comparing the number of packets of each access unit of the different substreams of the first type having the same timing marker for obtaining the longest access unit, and
making the length of the access units of the substreams of the first type having said timing marker equal by adding filling packets to the access units that are not the longest, in order to enable simplified seamless switch over between the content related media streams to be created.

According to a second aspect of the present invention, this object is also achieved by a media stream handling device for enabling simple seamless switch over between at least two content related media streams each comprising a number of access units having packets, and comprising:

at least one substream handler arranged to:
obtain substreams of a first type in a number corresponding to the number of content related media streams to be handled and also being grouped into access units, and
obtain a timing marker for each access unit of the different substreams of the first type, and

a controller arranged to:
compare the number of packets of each access unit of the different substreams of the first type having the same timing marker for obtaining the longest access unit, and
order said substream handler to make the length of the access units of the substreams of the first type having said timing marker equal by adding filling packets to the access units that are not the longest, in order to enable simplified seamless switch over between the content related media streams to be created.

According to a third aspect of the present invention this object is furthermore achieved by a computer program product to be used on a computer for enabling simple seamless switch over between at least two content related media streams each comprising a number of access units having packets and having a computer program code for making the computer, when said code is loaded into the computer:
at least enable substreams of a first type to be obtained in a number corresponding to the number of content related media streams to be provided and grouped into access units,
obtain a timing marker for each access unit of the different substreams of the first type,
compare the number of packets of each access unit of the different substreams of the first type having the same timing marker for obtaining the longest access unit, and
at least order the making of the length of the access units of the substreams of the first type having said timing marker equal by adding filling packets to the access units that are not the longest, in order to enable simplified seamless switch over between the content related media streams to be created.

Claims 2 and 7 are directed towards combining the substreams of the first type with additional data for providing the media streams and providing overhead data including a change over marker for access units that are entry access units within independent groups of access units. The change over marker will here, because of the previously made adjustments of the substreams, be provided for the same positions, and can therefore easily be used when the simple seamless switch over is performed.

Claims 3 and 4 are directed towards providing timing and positional markers in the overhead data to further simplify switch over.

According to claim 5 the first type of substream is a video stream and the additional data comprises one audio stream, which is combined with all video streams. This simplifies the making of the access units of the media streams equal in size.

Another object of the present invention is to provide a simple way of determining if a simple seamless switch over can be used for different content related media streams or not.

According to a fourth aspect of the present invention, this object is achieved by a method of selecting a switching scheme for at least two content related media streams each comprising a number of access units having packets and the method comprising the steps of:
obtaining overhead data related to each media stream,
comparing the overhead data of each media stream, and
selecting a simplified seamless switch over scheme, if the overhead data of the different streams have substantial similarities reflecting the fact that the access units corresponding to each other in the different streams have equal lengths obtained through filling packets.

According to a fifth aspect of the present invention, this object is also achieved by a device for selecting a switching scheme for at least two content related media streams each comprising a number of access units having packets and the device comprising a controller arranged to:
obtain overhead data related to each media stream,
compare the overhead data of each media stream, and
select a simplified switch over scheme if the overhead data of the different streams have substantial similarities reflecting the fact that the access units corresponding to each other in the different streams have equal lengths obtained through filling packets.

According to a sixth aspect of the present invention this object is furthermore achieved by a computer program product for selecting a switching scheme for at least two content related media streams each comprising a number of access units having packets and having a computer program code for making the computer, when said code is loaded into the computer:
obtain overhead data related to each media stream,
compare the overhead data of each media stream, and
select a simplified seamless switch over scheme if the overhead data of the different streams have substantial similarities reflecting the fact that the access units corresponding to each other in the different streams have equal lengths obtained through filling packets.

According to claims 10 and 11, the selection is based on examination of the “raw” overhead data. This feature has the advantage of avoiding decoding of the overhead data and thus provides a simple and fast selecting mechanism.

According to claims 12 and 13, the selection is based on extracted relevant EP-table entries, which EP tables are provided in the overhead data. This feature has the advantage of only using the information that is of relevance as a basis for the selection.

Another object of the present invention is to provide a simple seamless switch over mechanism between content related media streams.

According to a seventh aspect of the present invention, this object is achieved by a method of performing simplified seamless switch over between content related media streams during the playing of one of the streams, where each stream comprises a number of access units having packets and where the length of the access units that correspond to each other in the different streams is the same, obtained through filling packets, and the method comprises the steps of:
detecting a user selection of switch over from said one media stream to another media stream,
obtaining overhead data related to said one stream comprising at least one switch over marker indicating, possibly together with other markers, a position in said one stream where a switch over can be performed,
selecting the switch over marker closest to the position of the played stream at the point of the detected user selection, and
directly switching to playing from the other stream at the same position as the switch over marker is indicating in said one stream.

According to an eighth aspect of the present invention, this object is also achieved by a device for performing simplified seamless switch over between content related media streams during the playing of one of the streams, where each stream comprises a number of access units with packets and where the length of the access units that correspond to each other in the different streams is the same, obtained through filling packets, and the device comprises a controller arranged to:
detect a user selection of switch over from said one media stream to another media stream,
obtain overhead data related to said one stream comprising at least one switch over marker indicating, possibly together with other markers, a position in said one stream where a switch over can be performed,
select the switch over marker closest to the position of the played stream at the point of the detected user selection, and
order a decoder to directly switch to playing from the other stream at the same position as the switch over marker is indicating in said one stream.

According to a ninth aspect of the present invention this object is furthermore achieved by a computer program product for performing simplified seamless switch over between content related media streams during the playing of one of the streams, where each stream comprises a number of access units having packets and where the length of the access units corresponding to each other in the different streams is the same, obtained through filling packets, and the computer program product having a computer program code for making the computer, when said code is loaded into the computer:
detect a user selection of switch over from said one media stream to another media stream,
obtain overhead data related to said one stream comprising at least one switch over marker indicating, possibly together with other markers, a position in said one stream where a switch over can be performed,
select the switch over marker closest to the position of the played stream at the point of the detected user selection, and
order a direct switch to playing from the other stream at the same position as the switch over marker is indicating in said one stream.

Another object of the present invention is to provide a set of media signals, which are provided in such a way that they enable simple seamless switch over between media streams when being played.

According to a tenth aspect of the present invention, this object is achieved by a set of media signals, comprising:
a number of content related media streams where each stream comprises a number of access units having packets, where the length of the access units corresponding to each other in the different streams is the same, obtained through filling packets, and
overhead data corresponding to each media stream, where said overhead data comprises switch over markers indicating, possibly together with other markers, the switch over positions in the streams, in order to enable simplified seamless switch over between the content related media streams.

The expression content related media streams is intended to mean that the content coded in the streams is the same, but possibly from different angles, and then coded in such a way that access units have the same timing when to be presented at least regarding a so-called closed Group of Pictures (GOP).

With the present invention several advantages are obtained. The creation of media streams is a simple one that does not require any special encoding of source video material and complex mastering of the different content related streams in order to meet coding requirements. The recognition of such a media stream is furthermore simpler, because that can easily be found out by a simple analysis of the overhead data without having to analyze the transport streams. Finally, the switch over scheme has the advantage of being simple and not needing to analyze more than the overhead data associated with the media stream being played. This saves time and memory in the player and also keeps the complexity of the player low.

The basic idea of the invention is to make the access units of the different content related media streams equal in size by adding filling packets. This fact makes the streams similar in size and therefore enables simpler switch over from one stream to another. This also makes it possible to have overhead data for the streams appear similar, which is advantageous when a switching scheme to be used is determined.

The above mentioned and other aspects of the invention will be apparent from and elucidated with reference to the embodiments described hereinafter.

### BRIEF DESCRIPTION OF THE DRAWINGS

The present invention will be further described in relation to the accompanying drawings, in which:

FIG. 1 shows a block schematic of a media mastering device according to the present invention,

FIG. 2 shows a flow chart of a method of enabling simplified switch over according to the present invention according to which the device in FIG. 1 is operating,

FIG. 3 schematically shows three transport streams that have been aligned with each other according to the principles of the present invention,

FIGS. 4a and b schematically show the relevant content of EP tables provided in overhead data shown in FIG. 3,

FIG. 5 shows a block schematic of a media playing device according to the present invention,

FIG. 6 shows a flow chart of a method of selecting a switching scheme according to the present invention,

FIG. 7 shows a flow chart of a method of simplified switch over between different media streams according to the present invention, and

FIG. 8 schematically shows a computer program product in the form of a CD ROM disc having a computer program code for performing the methods according to the present invention.

### DETAILED DESCRIPTION OF THE INVENTION

The present invention is generally directed towards seamless switching over among content related media streams, like for instance among different angles of the same content that has been coded into three different transport streams. In the following a system for providing this facility will be described in relation to MPEG coded media data in the form of transport streams that are stored on an optical disc according to the Blu-ray standard. It should however be realized that the invention is not limited to Blu-ray or even MPEG, but can be used on other standards having suitable similar properties. The invention is furthermore not limited to such media streams which are provided on an optical disc, but they can be stored on any suitable storage medium, such as hard disks or memory sticks.

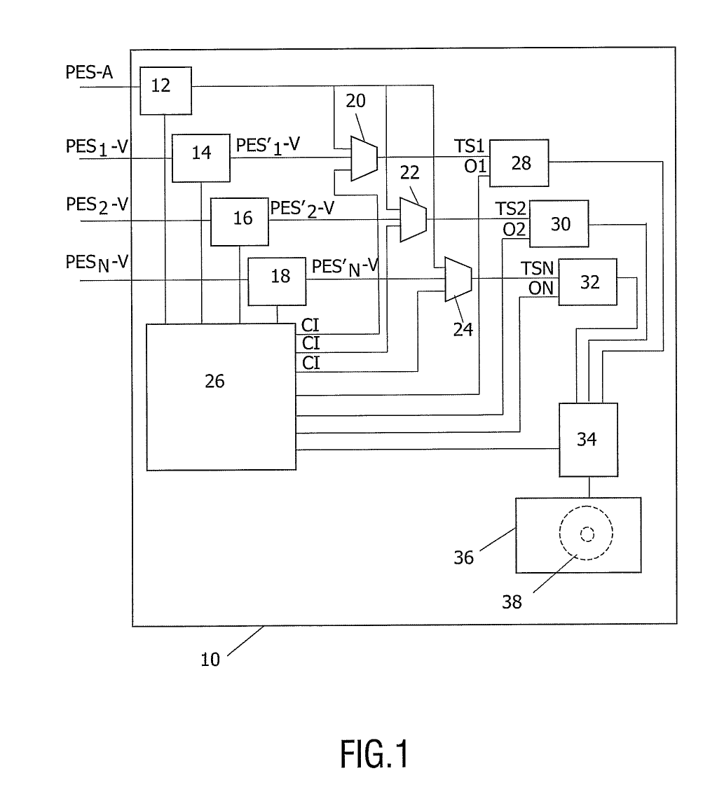

FIG. 1 shows a block schematic of a media stream handling device or media mastering device 10. The device comprises a number of substream handlers 12, 14, 16, 18, where an audio handler 12 handles audio substreams and first, second and nth handlers 14, 16, 18 handle video substreams. The first handler 14 is connected to a first substream combiner in the form of a first multiplexer 20, the second handler 16 is connected to a second substream combiner or multiplexer 22 and the nth substream handler 18 is connected to an nth substream combiner or multiplexer 24. All the substream handlers 12, 14, 16, 18, including the audio handler 12, are connected to an encoding controller 26, which in turn is also connected to all the multiplexers 20, 22, 24. The first multiplexer 20 is connected to a first stream combiner 28, the second multiplexer 22 to a second stream combiner 30 and the nth multiplexer 24 to an nth stream combiner 32. Also the controller 26 is connected to the stream combiners 28, 30, 32. The stream combiners 28, 30 and 32 are furthermore connected to a writing unit 36, to which also the controller 26 is connected. The writing unit 36 is finally connected to a disc drive 36 including an optical disc 38 on which media data can be written.

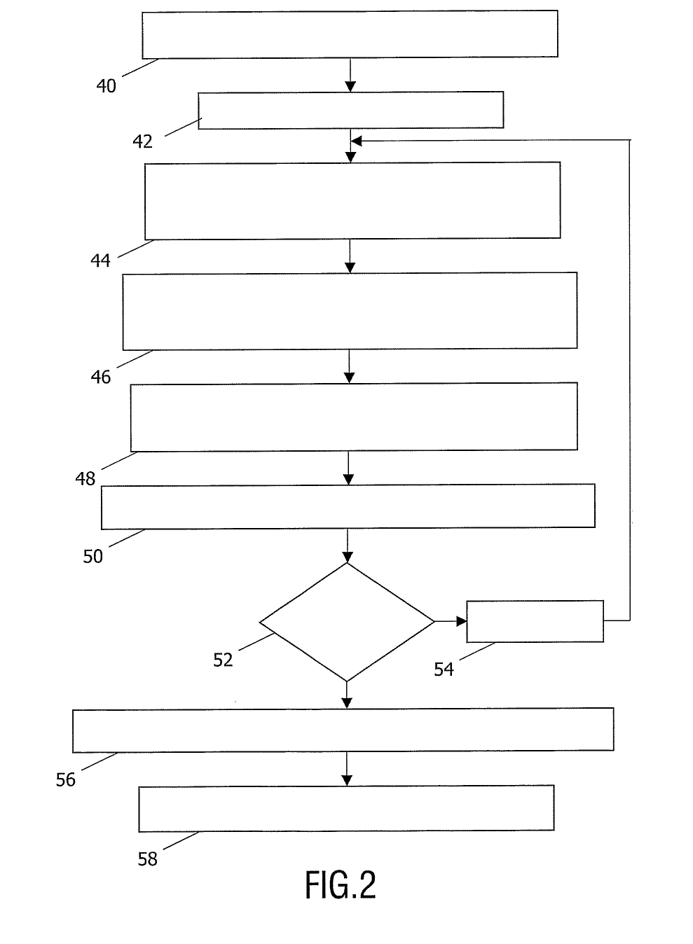

The creation of content related media streams out of a number of substreams will now be described with reference being made to FIG. 1 and 2, where the latter shows a flow chart of the method according to which the device in FIG. 1 is working .

The device first receives content related substreams in the form of packetised elementary streams PES, The device receives one such audio stream PES-A and a number of video streams PES₁-V, PES₂-V and PES_{N}-V. The video substreams PES₁-V, PES₂-V and PES_{N}-V are here different angles of the same content, which content thus has been captured with n different cameras. It should be realized that although three are shown in the figure, that more or fewer angles can be provided. The substreams are divided into access units AU that are made up of a number of video packets according to the MPEG standard. An independent group of access units or closed GOP (Group Of Pictures) is here indicated through information provided in the video substreams that point out an entry point in the form of the first video packet of the first access unit in the closed GOP. This first access unit of the closed GOP is here also called an entry access unit. A closed GOP is a set of access units that have content that can be presented separately without the need for information from other access units outside the group. The closed GOPs in the different streams have furthermore been generated in such a way that they have common timing markers or time stamps PTS (Presentation Time Stamp) and the same number of access units. This means that the content in the different video substreams are related to each other and synchronized in such a way that a closed GOP in one video substream has corresponding closed GOPs in the other video substreams with the same time stamp. Finally the audio stream is also divided into access units and has time stamps in the same fashion.

The different substreams are thus applied to the different substream handlers 12, 14, 16, 18, which units thus receive these streams, step 40. The controller thereafter sets an access unit counter AU to one, step 42. For a given access unit AU the video substream handler 14, 16, 18 thereafter extracts the presentation time stamps, positions of the access units in the substreams and information of the video packets and closed GOP indications if there are any from the streams PES₁-V, PES₂-V and PES_{N}-V and supplies this information to the controller 26, step 44. The controller 26 then compares the number of packets of the streams in the access unit in question with each other, step 46. The controller 26 thereafter selects the substream having the most packets in the current access unit as a reference and proceeds to make the access units equal in size, step 48. This is done by ordering the substream handlers handling the other substreams to add filling packets in the form of null packets N to the access unit in order to make the lengths equal. A substream handler thus pads the video streams with these packets in the access unit in question. If the access unit is the first access unit of a closed GOP, the controller 26 then sets an angle switch point or a switch over marker SOM by giving the SOM a value of one, and if not the SOM marker gets a value of zero, step 50. Thereafter the controller 26 finds out if the access unit was the last access unit of the substreams, step 52. If it was not, the access unit counter is increased by one, step 54, and the controller 26 goes back and repeats steps 44-50. If it was the last access unit, the controller 26 orders the multiplexing of the thus modified substreams PES′₁-V, PES′₂-V and PES′_{N}-V with the audio substream PES-A and stream control information CI in order to create media or transport streams TS1, TS2, TSN, which stream control information CI is provided to the multiplexers 20, 22, 24 by the controller 26, step 56. This audio substream and the stream control information is provided in a way that meets the Blu-ray specification requirements. The stream control information can include control packets SC, in the form of PAT (Program Association Table), PMT (Program Map Table) or PCR (Program Clock Reference) packets. Thereafter the controller 26 creates overhead data associated with the created transport streams TS1, TS2, TSN in the form of n separate overhead data or clip info files O1, O2, ON, the overhead data files then include so-called EP-tables (Entry Point tables) for each access unit and pointing to the first video packet of the access unit, step 58. The structure of the EP table will be described in more detail later. After that the controller 26 supplies the overhead data O1, O2, ON to the combiners 28, 30, 32, where they are combined with the transport streams TS1, TS2, TSN supplied by the multiplexers 14, 16, 18. Finally the controller 26 makes the writing unit 34 record the combined streams and clip info files on the disc 38 in the disc drive 36.

The different method steps described above in relation to FIG. 2 are also provided in table I provided below.

TABLE I

| | |
|---|---|
| 40 | RECEIVE PES1-V, PES2-V, PESN-V, PES-A |
| 42 | AU = 1 |
| 44 | EXTRACT PTS + POSSIBLE CLOSED GOP INFO FOR PES1-V, |
| | PES2-V, PESN-V |
| 46 | COMPARE IN AU NUMBER OF PACKETS OF PES1-V WITH |
| | NUMBER OF PACKETS OF PES2-V, PESN-V |
| 48 | MAKE LENGTH EQUAL BY ADDING N PACKETS TO |
| | SHORTER STREAM FR |
| 50 | SET SOM = 1 IF CLOSED GOP OTHERWISE SET SOM = 0 |
| 52 | LAST AU? |
| 54 | AU = AU + 1 |
| 56 | MULTIPLEX PES'1-V, PES'2-V, PES'N-V WITH PES-A AND CI |
| 58 | CREATE O1, O2, ON FOR TS1, TS2 AND TSN |

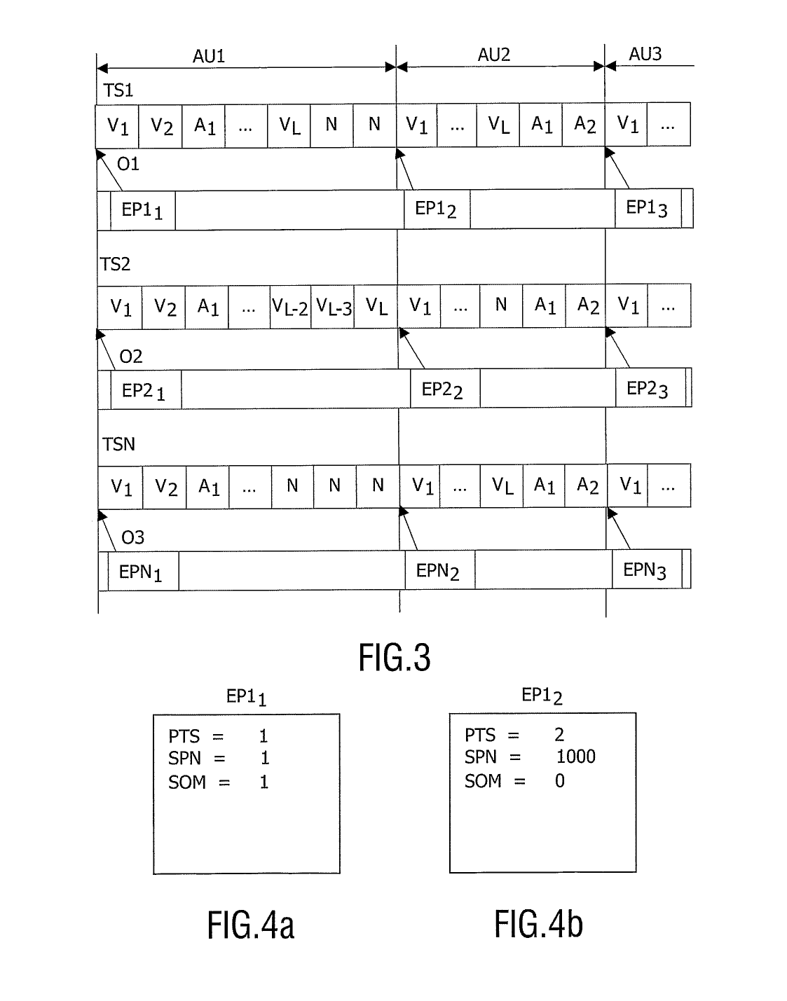

FIG. 3 shows the structure of the content related media streams created by the device 10 and FIG. 4a and 4b show the content of two EP-tables provided in overhead data associated with the streams in FIG. 3.

In FIG. 3 is shown an exemplifying structure of the created transport streams TS1, TS2, TSN and the overhead data O1, O2, ON associated with the streams. A first access unit AU1 is started with a first video packet V₁ in all streams TS1, TS2, TSN followed by a second video packet V₂ and a first audio packet A₁. Then there follows a variety of packets until the end of the first access unit AU1. These packets between the beginning and end are indicated with dots. The second substream was the longest for this access unit AU1 , which is seen with the video packets V_{L-2}, V_{L-3} and V_{L} ending the access unit of the corresponding transport stream TS2, whereas the first substream was two packets shorter and the nₜₕ substream was three packets shorter, because of which the latter two streams receive the corresponding number of null packets N in order to make the lengths equal as can be seen in the corresponding transport streams TS1 and TSN. In the second access unit AU2, the first and nth substreams are the longest, which is indicated by the last video packets VL having the same position in the corresponding transport streams TS1, TSN, while the second substream was the shorter, consequently here the corresponding transport stream TS2 has received null packets N. As is also evident from FIG. 3, the first video packet VI of the access units each have an EP table EP1₁, EP1₂, EP1₃, EP2₁, EP2₂, EP2₃, EPN₁, EPN₂, EPN₃ in the corresponding overhead data O1, O2, ON poiting to them, where the EP table points at the first video packet V₁ position in the transport stream. From FIG. 4a and 4b it can be seen that EP-tables include information of when the access unit is to be presented through a presentation time stamp PTS and the position of the first video packet V₁ of the access unit in the transport stream by a source packet number SPN. It also includes the switch over marker SOM. As the first video packet V₁ of AU1 is the entry point to a closed GOP, the EP table EP1₁, EP2₁ and EPN1 will here have the SOM set, i.e. have a value of one. The second access unit AU2 is not such an entry point access unit and consequently the SOM is not set, i.e. it has a value of zero. Since the video streams are multiplexed with the same audio stream, it is guaranteed that the access units having the same time stamps are provided at the same positions in all streams. From this and the fact that corresponding closed GOPs have the same PTS it also follows that the closed GOP is provided at the same positions in all streams. Naturally the access units within a closed GOP can differ somewhat within the different streams, like be different I-, B- and P-access unit combinations, and therefore there might be different types of stream control information in the overhead data, but there will be substantial similarities in both the transport streams and the overhead data. The advantages of these similarities will be described in more detail later.

The above described creation of media streams has the advantage of being simple and not requiring any special encoding of source video material and complex mastering of the different content related streams in order to meet coding requirements, like Blu-ray requirements. In standard encoders this could need the involvement of special encoding of the video, requiring strict encoder control, which might be hard to achieve, lead to high costs and time involvements while mastering a disc. Therefore the present invention can be applied in consumer equipment. Furthermore, by using a closed GOP for encoding the switch over marker, the encoding is easy to control for most hardware and software MPEG encoders.

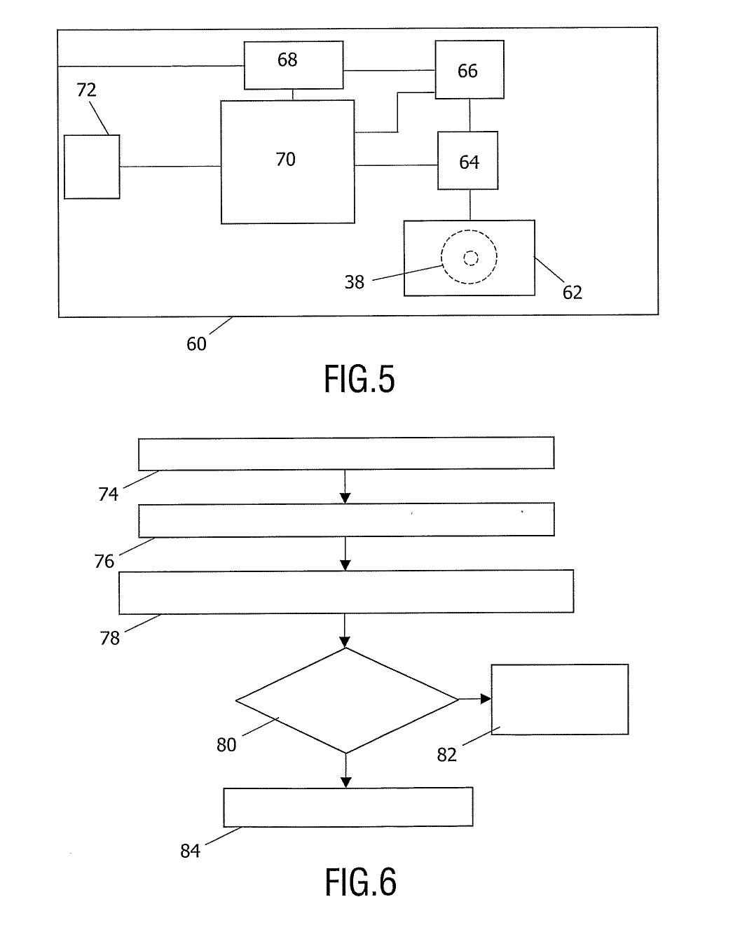

FIG. 5 shows a block schematic of a combined device for selecting switching scheme for at least two content related media streams and for performing simplified seamless switch over between content related media streams during the playing of a media or transport stream in the form of a media playing device 60, which here is a simplified Blu-ray player 60. The player 60 includes an optical disc drive 62 arranged to receive a Blu-ray disc 38 on which are stored a number of media streams coded according to the Blu-ray standard of different angles of the same content. The disc drive 62 is connected to a reading unit 64 for reading information on the disc 38 in the form of combined transport stream and overhead data. The reading unit 64 is furthermore connected to a stream separator 66, which removes overhead data that is encoded with the transport stream. The stream separator 66 is connected to a presentation controller 70 and to a media decoder 68, which media decoder 68 provides decoded media signals, which in this embodiment are decoded MPEG video and audio signals intended for, for instance, a television set. A user interface 72 is connected to the controller 70 of the device 60 in order to allow a user to make selections of media streams or clips. The controller 70 is also connected to the media decoder 68 and the reading unit 64.

A first type of operation of the device in FIG. 5 will now be described with reference being made to FIGS. 3, 4a, 4b, 5 and 6, where the latter shows a flow chart of a method of selecting switching scheme that the device 60 uses.

It is first assumed that the disc 38 in the disc drive 62 includes transport streams TS1-TSN and corresponding overhead data O1-ON. The method starts by the controller 70 ordering the reading unit 64 to fetch all overhead data from the disc, step 76. In the present embodiment the overhead data is being combined with the transport streams. The combined stream and data are then received by the reading unit, which forwards them to the separator 66. The controller 70 therefore receives the overhead data in the form of the clip info files O1, O2, ON from the separator 66. The controller 70 then continues and extracts the EP tables of the overhead data, step 76. Thereafter the controller compares the PTS and SOM fields for the same source packet numbers SPN for all clip info files, step 78. This means that all EP, tables are compared with each other, all EP₂ tables are compared with each other etc. If these fields are then not identical, step 80, a standard switch over method is selected, step 82. If however they are identical, step 80, a simplified scheme is selected, step 84. The simplified scheme will be described later on.

The different method steps described above in relation to FIG. 6 are also provided in table II below.

TABLE II

| | |
|---|---|
| 74 | FETCH O1, O2, ON |
| 76 | EXTRACT ALL EP-TABLES FROM O1, O2, |
| | ON |
| 78 | COMPARE PTS, SPN AND SOM OF ALL EP |
| | TABLES |
| 80 | IDENTICAL? |
| 82 | STANDARD SCHEME |
| 84 | SIMPLIFIED SCHEME |

This method of selecting a scheme can be varied in several ways. It is firstly possible that the only EP-tables compared are the EP tables where a SOM setting exists, i.e. SOM is set to one, in order to reduce the number of comparisons. Here too it should be realised that the EP tables could include more information that differ from clip info file to clip info file. This differing data is then not used in the comparison. Another possible variation is that the clip info files are not decoded, i.e. that the EP tables are not extracted, for obtaining entries in the EP tables in order to find out if the simplified scheme is to be used or not. Instead it is possible that the controller looks at the raw clip info files and first investigates if the lengths of them are the same for all streams. The controller then goes on and sees if the data in the clip info files is essentially the same, by looking at the binary values of the files. These values should be identical, perhaps except for some limited regularly recurring parts that differ. These differing parts should then occur at the same positions that recur periodically in limited sections of the clip info files. The only data in the clip info files that should differ from each other should here be the fields that contain information about the original sizes of MPEG pictures.

The recognition whether a simple switch over scheme is to be used is easily made, since it only requires a look at the overhead data and requires no analysis of the media streams, which would normally be the case. Since these streams are normally considerable large, this does without the processing and time required for such analysis needed for it.

A method of simplified seamless switch over between two different transport streams performed by the device in FIG. 5 will now be described with reference being made to FIGS. 3, 4a, 4b, 5 and 7, the latter of which showing a flow chart of a method of a performing simplified switch over.

The method starts by a user selecting to play a transport stream TS via the interface 72. The controller 70 therefore receives such a selection, step 85. As an illustrating example it is assumed that the selection is the selection of TS1 in FIG. 3. The controller 70 then orders the reading unit 64 to read the transport stream TS1 and corresponding overhead data O1 from the disc 38 in disc drive 62 in order to fetch the selected transport stream and corresponding overhead data, step 86. The reading unit 64 supplies the combined stream and overhead data to the separator 66, which separates them and applies the transport stream TS1 to the media decoder 68, which decodes the stream in a normal and well-known fashion, and the overhead data O1 to the controller 70. The controller 70 then orders the start of the playing of the stream TS1 from the beginning or perhaps from some other user-selected position, step 88. The controller 70 thereafter receives a user selection of a switch over to another transport stream via the interface 72, step 90, which as an example can be to the second stream TS2. The controller 70 in the same way orders the fetching of the second stream TS2 from the disc 38 as it ordered the fetching of the first stream TS1, step 92. The controller 70 then goes on and looks in the overhead data O1 associated with the first transport stream TS1 and finds the closest position in the stream where an EP table containing a SOM set to one exists, step 94. The decoder 68 continues playing the first stream to that position, which position is indicated by the PTS and SPM markers and is then ordered to directly switch over to the same SPM position in the second stream TS2, step 96. Thus the controller does not consult the second overhead data O2 and the EP-tables there, but directly orders a jump to the same position indicated by the EP table of the first overhead stream O1, which is the corresponding switch over position because of the previously described mastering.

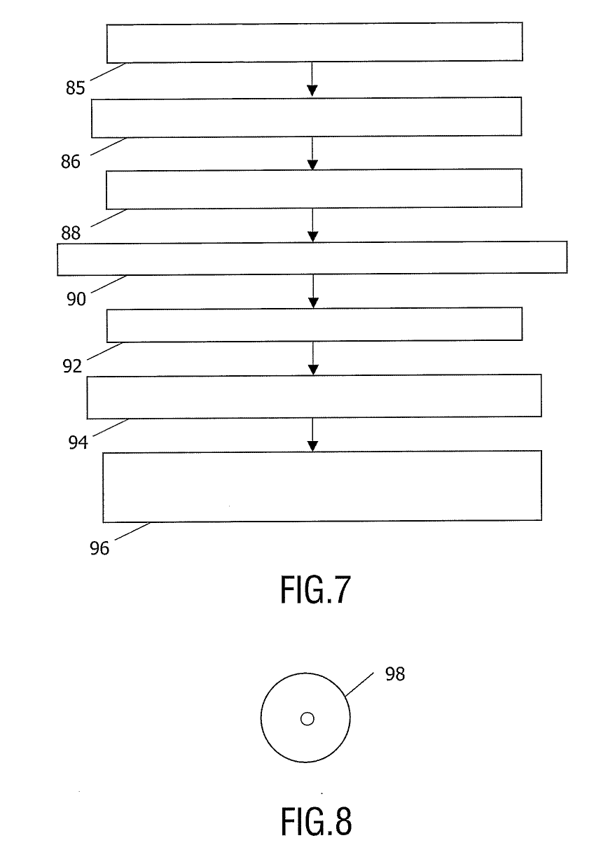

The different method steps described above in relation to FIG. 7 are also shown in table III below.

TABLE III

| | |
|---|---|
| 85 | RECEIVE USER SELECTION OF TS |
| 86 | FETCH SELECTED TS AND CORRESPONDING O |
| 88 | PLAY SELECTED TS |
| 90 | RECEIVE USER SELECTION OF SWITCH TO OTHER TS |
| 92 | FETCH OTHER TS |
| 94 | FIND CLOSEST EP-TABLE OF O WHERE SOM = 1 |
| 96 | DIRECTLY SWITCH TO OTHER TS AT POSITION INDICATED |
| | BY EP-TABLE IN O |

The above described way of directly switching over greatly simplifies the processing in the controller and also allows the provision of a simpler player, which will be advantageous with respect to costs. Another advantage of this scheme is that a switch over is made much more quickly since fewer computing steps have to be performed, which is an advantage to the end user. This aspect of the invention is thus saving both time and memory.

The encoding and presentation controllers in both the devices are preferably each provided in the form of a processor with associated program code for performing the method according to the invention. Also the different handlers can be provided in the form of program code associated with the processor. Such program codes can also be provided on a data carrier, where one in the form of a CD Rom disc 98 is shown in FIG. 8. The program code can furthermore be provided on a server and downloaded into the media presentation device. The media presentation device furthermore need not be a Blu-ray disc player, but can for instance also be a computer like a PC (Personal Computer).

There are a number of variations that can be made to present invention. The invention is not limited to multiplexed audio and video substreams but can for instance be used for video substreams only. In this case there would be no need for an audio substream handler. It is not necessary to provide the transport streams combined with the clip info files, but these can be provided separately. In this case there would not be a need for stream separators and stream combiners. It is furthermore possible to combine the two devices into a combined mastering/playing device. The streams that are multiplexed together in order to form the transport streams can furthermore include more streams, such as presentation and graphics streams.

It should be emphasized that the term “comprises/comprising” when used in this specification is taken to specify the presence of stated features, integers, steps or components, but does not preclude the presence or addition of one or more other features, integers, steps, components or groups thereof. It should furthermore be realized that reference signs appearing in the claims should in no way be construed as limiting the scope of the present invention.

1. Method of enabling simple seamless switch over between at least two content related media streams (TS1, TS2, TSN) each comprising a number of access units (AU1, AU2, AU3) having packets and the method comprising the steps of:
obtaining substreams (PES₁-V, PES₂-V, PES_{N}-V) of a first type in a number corresponding to the number of content related media streams to be provided and also being grouped into access units, (step 40),
obtaining a timing marker (PTS) for each access unit of the different substreams of the first type, (step 44),
comparing the number of packets of each access unit of the different substreams of the first type having the same timing marker for obtaining the longest access unit, (step 46), and
making the length of the access units of the substreams of the first type having said timing marker equal by adding filling packets (N) to the access units that are not the longest, (step 48), in order to enable simplified seamless switch over between the content related media streams to be created.

2. Method according to claim 1, wherein the substreams of the first type are divided into independent groups of access units, where there are, for a certain entry access unit (AU1) of an independent group of access units of one substream of the first type, corresponding entry access units and an identical timing marker for the other substreams of the first type and further comprising the steps of:
determining for each access unit of each substream of the first type, whether the access unit is an entry access unit within an independent group of access units, (step 50), combining each substream of the first type with essentially the same additional data (PES-A, CI) for providing the media streams (TS1, TS2, TSn), (step 56), and providing overhead data (O1, O2, ON, EP1₁, EP1₂, EP1₃, EP2₁, EP2₂, EP2₃, EPN₁, EPN₂, EPN₃) in relation to each media stream at least comprising a change over marker (SOM) associated with each entry access unit of an independent group of access units, (step 50), thus indicating the same switch over position in the different media streams.

3. Method according to claim 2, wherein the overhead data also comprises the timing markers (PTS) of said entry access units.

4. Method according to claim 3, wherein the overhead data also includes a position marker (SPN) for each entry access unit, which position marker is identical for all media streams.

5. Method according to claim 2, wherein the first type of substream is a video stream and additional data comprises one substream of a second type (PES-A) that is audio and the step of combining comprises combining said one audio substream with all video sub streams.

6. Media stream handling device (10) for enabling simple seamless switch over between at least two content related media streams (TS1, TS2, TSN) each comprising a number of access units (AU1, AU2, AU3) having packets, and the device comprising:
at least one substream handler (14, 16, 18) arranged to:
obtain substreams (PES₁-V, PES₂-V, PES_{N}-V) of a first type in a number corresponding to the number of content related media streams to be handled and also being grouped into access units, and
obtain a timing marker (PTS) for each access unit of the different substreams of the first type, and
a controller (26) arranged to:
compare the number of packets of each access unit of the different substreams of the first type having the same timing marker for obtaining the longest access unit, and
order said substream handler to make the length of the access units of the substreams of the first type having said timing marker equal by adding filling packets (N) to the access units that are not the longest, in order to enable simplified seamless switch over between the content related media streams to be created.

7. Device according to claim 6, wherein the substreams of the first type are divided into independent groups of access units, where there are, for a certain entry access unit (AU1) of an independent group of access units of one substream of the first type, corresponding entry access units and an identical timing marker (PTS) for the other substreams of the first type and the device further comprising:
substream combiners (20, 22, 24) arranged to combine each substream of the first type with essentially the same additional data (PES-A, CI) for providing the media streams (TS1, TS2, TSN),
wherein said controller is further arranged to:
determine for each access unit of each substream of the first type, whether the access unit is an entry access unit within an independent group of access units, and
provide overhead data (O1, O2, ON, EP1₁, EP1₂, EP1₃, EP2₁, EP2₂, EP2₃, EPN₁, EPN₂, EPN₃) in relation to each media stream at least comprising a change over marker (SOM) associated with each entry access unit of an independent group of access units, thus indicating the same switch over position in the different media streams.

8. Computer program product (98) to be used on a computer for enabling simple seamless switch over between at least two content related media streams (TS1, TS2, TSN) each comprising a number of access units (AU1, AU2, AU3) having packets and having a computer program code for making the computer execute, when said code is loaded into the computer:
at least enable substreams (PES₁-V, PES₂-V, PES_{N}-V) of a first type to be obtained in a number corresponding to the number of content related media streams to be provided and grouped into access units,
obtain a timing marker (PTS) for each access unit of the different substreams of the first type,
compare the number of packets of each access unit of the different substreams of the first type having the same timing marker for obtaining the longest access unit, and
at least order the making of the length of the access units of the substreams of the first type having said timing marker equal by adding filling packets (N) to the access units that are not the longest, in order to enable simplified seamless switch over between the content related media streams to be created.

9. Method of selecting a switching scheme for at least two content related media streams (TS1, TS2, TSN) each comprising a number of access units (AU1, AU2, AU3) having packets and the method comprising the steps of:
obtaining overhead data (O1, O2, ON) related to each media stream, (step 74), comparing the overhead data of each media stream, (step 78), and selecting a simplified seamless switch over scheme, (step 84), if the overhead data of the different streams have substantial similarities reflecting the fact that the access units corresponding to each other in the different streams have equal lengths obtained through filling packets (N).

10. Method according to claim 9, wherein the step of selecting comprises selecting the simplified scheme if the length of the overhead data is the same for all streams.

11. Method according to claim 10, wherein the step of selecting comprises selecting the simplified scheme if the overhead data is the same for the different streams perhaps except for a limited periodic pattern.

12. Method according to claim 9, wherein said overhead data comprises EP tables (EP₁, EP1₂, EP1₃, EP2₁, EP2₂, EP2₃, EPN₁, EPN₂, EPN₃) comprising timing markers (PTS) and switch over markers (SOM) and further comprising the step of extracting said EP tables from the overhead data, (step 76), and the step of selecting is performed if at least switch over markers and corresponding timing markers are identical in corresponding EP tables of the streams.

13. Method according to claim 12, wherein said EP tables further comprise position markers (SPN) and the step of selecting simplified switching over is also performed if the position markers in the corresponding EP tables are identical.

14. Method according to claim 9, further comprising the steps of obtaining at least one of said media streams, playing said one of the media streams, detecting a user selection of switch over from said stream to another stream, obtaining a switch over marker (SOM) in the overhead data corresponding to said one stream being closest to the position of the played stream at the point of the detected user selection and directly switching over to the same position in the selected stream that the switch over marker is pointing to in the first stream.

15. Device (60) for selecting a switching scheme for at least two content related media streams (TS1, TS2, TSN) each comprising a number of access units (AU1, AU2, AU3) having packets and comprising a controller (70) arranged to:
obtain overhead data (O1, O2, ON) related to each media stream,
compare the overhead data of each media stream, and
select a simplified seamless switch over scheme if the overhead data of the different streams have substantial similarities reflecting the fact that the access units corresponding to each other in the different streams have equal lengths obtained through filling packets (N).

16. Computer program product (98) for selecting a switching scheme for at least two content related media streams (TS1, TS2, TSN) each comprising a number of access units (AU1, AU2, AU3) having packets and the computer program product (98) having a computer program code for making the computer, when said code is loaded into the computer:
obtain overhead data (O1, O2, ON) related to each media stream, compare the overhead data of each media stream, and select a simplified seamless switch over scheme if the overhead data of the different streams have substantial similarities reflecting the fact that the access units corresponding to each other in the different streams have equal lengths obtained through filling packets (N).

17. Method of performing simplified seamless switch over between content related media streams (TS1, TS2, TSN) during the playing of one of the streams (TS1), where each stream comprises a number of access units (AU1, AU2, AU3) having packets and where the length of the access units corresponding to each other in the different streams have equal lengths obtained through filling packets (N), and comprising the steps of:
detecting a user selection of switch over from said one media stream to another media stream (TS2), (step 85),
obtaining overhead data (O1) related to said one stream comprising at least one switch over marker (SOM) indicating, possibly together with other markers, a position in said one stream where a switch over can be performed, (step 86), selecting the switch over marker closest to the position of the played stream at the point of the detected user selection, (step 94), and directly switching to playing from the other stream at the same position as the switch over marker is indicating in said one stream, (step 96).

18. Device (60) for performing simplified seamless switch over between content related media streams (TS1, TS2, TSN) during the playing of one of the streams (TS1), where each stream comprises a number of access units (AU1, AU2, AU3) having packets and where the length of the access units corresponding to each other in the different streams have equal lengths obtained through filling packets (N), and comprising a controller (70) arranged to:
detect a user selection of switch over from said one media stream to another media stream (TS2),
obtain overhead data (O1) related to said one stream comprising at least one switch over marker (SOM) indicating, possibly together with other markers, a position in said one stream where a switch over can be performed,
select the switch over marker closest to the position of the played stream at the point of the detected user selection, and
order a decoder (68) to directly switch to playing from the other stream at the same position as the switch over marker is indicating in said one stream.

19. Computer program product (98) for performing simplified seamless switch over between content related media streams (TS1, TS2, TSN) during the playing of one of the streams (TS1), where each stream comprises a number of access units (AU1, AU2, AU3) having packets and where the length of the access units corresponding to each other in the different streams have equal lengths obtained through filling packets (N), and the computer program product (98) having a computer program code for making the computer, when said code is loaded into the computer:
detect a user selection of switch over from said one media stream to another media stream,
obtain overhead data related to said one stream comprising at least one switch over marker (SOM) indicating, possibly together with other markers, a position in said one stream where a switch over can be performed,
select the switch over marker closest to the position of the played stream at the point of the detected user selection, and
order a direct switch to playing from the other stream at the same position as the switch over marker is indicating in said one stream.

20. A set of media signals, comprising:
a number of content related media streams (TS1, TS2, TSN) where each stream comprises a number of access units (AU1, AU2, AU3) having packets, where the length of the access units corresponding to each other in the different streams is the same, obtained through filling packets (N), and
overhead data (O1, O2, ON) corresponding to each media stream, where said overhead data comprises switch over markers (SOM) indicating, possibly together with other markers, the switch over positions in the streams, in order to enable simplified seamless switch over between the content related media streams.
